(19) United States
(12) Patent Application Publication
(10) Pub. No.: US 2024/0342869 A1
(43) Pub. Date: Oct. 17, 2024

(54) TOOL ACCESSORY AND METHOD OF MANUFACTURING SAME

(71) Applicant: MILWAUKEE ELECTRIC TOOL CORPORATION, Brookfield, WI (US)

(72) Inventor: Devin W. Herritz, Sussex, WI (US)

(21) Appl. No.: 18/635,521

(22) Filed: Apr. 15, 2024

Related U.S. Application Data
(60) Provisional application No. 63/459,384, filed on Apr. 14, 2023.

(51) Int. Cl. B25B 15/00; B25B 23/00; C21D 1/18; C21D 1/42; C21D 9/00

(52) U.S. Cl. CPC B25B 15/002; B25B 23/0035; C21D 1/18; C21D 1/42; C21D 9/0068

(57) ABSTRACT

A tool accessory includes a drive portion configured to be engaged by an output shaft of a tool. The drive portion has a first hardness. The tool accessory further includes a tip configured to engage a workpiece. The tip has a second hardness different than the first hardness. The tool accessory further includes a shank interconnecting the drive portion and the tip. The shank has a third hardness different than the first hardness and different than the second hardness. The third hardness is between the first hardness and the second hardness, and the drive portion, the shank, and the tip are formed as a unitary body from a common material.

### CROSS-REFERENCE TO RELATED APPLICATION

This application claims priority to U.S. Provisional Patent Application No. 63/459,384 filed on Apr. 14, 2023, the entire contents of which are incorporated herein by reference.

### FIELD

The present disclosure relates to tool accessories. More particularly, the present disclosure relates to bit sockets and like accessories (e.g., tool bits, drill bits, insert bits, or the like) for use with a driver tool, such as a power tool (e.g., impact driver, drill, etc.) or a hand tool (e.g., socket wrench, socket wrench screwdriver, etc.).

### BACKGROUND

Bit sockets and other tool accessories must often fulfill two competing requirements. First, bit engaging surfaces must have sufficient wear resistance and hardness to allow for strong engagement over a reasonable life of the bit socket. Second, tool shank engaging surfaces must have sufficient toughness and impact resistance to resist failure due to cyclical stresses, such as use with an impact driver. In general, high wear resistance requires a high material hardness, which, in turn, results in lower toughness and impact resistance.

### SUMMARY

In some aspects, the techniques described herein relate to a tool accessory includes a drive portion configured to be engaged by an output shaft of a tool, the drive portion having a first hardness; a tip configured to engage a workpiece, the tip having a second hardness different than the first hardness; and a shank interconnecting the drive portion and the tip, the shank having a third hardness different than the first hardness and different than the second hardness, wherein the third hardness is between the first hardness and the second hardness, and wherein the drive portion, the shank, and the tip are formed as a unitary body from a common material.

In some aspects, the techniques described herein relate to a tool accessory, wherein the drive portion has a first toughness, wherein the tip has a second toughness different than the first toughness, wherein the shank has a third toughness different than the first toughness and different than the second toughness, and wherein the third toughness is between the first toughness and the second toughness.

In some aspects, the techniques described herein relate to a tool accessory, wherein the drive portion, the tip, and the shank are initially subjected to a first heat treatment to temporarily unify the hardness and the toughness of the tool accessory, and wherein one of the drive portion and the tip are subsequently subjected to a second heat treatment different than the first heat treatment.

In some aspects, the techniques described herein relate to a tool accessory, wherein the drive portion and not the tip is subjected to the second heat treatment, and wherein an amount of the shank that is subjected to the second heat treatment decreases from the drive portion to the tip.

In some aspects, the techniques described herein relate to a tool accessory, wherein the tip and not the drive portion is subjected to the second heat treatment, and wherein an amount of the shank that is subjected to the second heat treatment decreases from the tip to the drive portion.

In some aspects, the techniques described herein relate to a tool accessory, wherein the drive portion includes a socket for receiving the output shaft of the tool, and wherein the socket has substantially polygonal cross-section.

In some aspects, the techniques described herein relate to a tool accessory, wherein one of the output shaft and the drive portion includes a detent ball, and the other of the output shaft and the drive portion includes a recess for receiving the detent ball, and wherein the socket has a substantially square cross-section.

In some aspects, the techniques described herein relate to a tool accessory, wherein the second heat treatment incudes induction tempering.

In some aspects, the techniques described herein relate to a tool accessory, wherein the first hardness is approximately 44-52 HRC, wherein the second hardness is approximately 57-62 HRC, and wherein the third hardness is approximately 46-62 HRC.

In some aspects, the techniques described herein relate to a tool accessory, wherein the first hardness is approximately 48 HRC, and wherein the second hardness is approximately 60 HRC.

In some aspects, the techniques described herein relate to a tool accessory including a unitary body including a first end, a second end opposite the first end, and an intermediate portion extending axially between the first end and the second end, the first end, the second end, and the intermediate portion being formed from a common material. The tool accessory further includes a first zone extending between the first end and a first side of the intermediate portion, the first zone having a first hardness; a second zone extending between the second end and a second side the intermediate portion, the second zone having a second hardness different than the first hardness; and a transition zone between the first zone and the second zone, at least a portion the transition zone having a hardness gradient between the first hardness and the second hardness, wherein the first side has undergone a first material treatment configured to provide the first hardness, and wherein the second side has undergone a second material treatment that is different than the first material treatment and configured to provide the second hardness.

In some aspects, the techniques described herein relate to a tool accessory, wherein the second side has undergone the first material treatment and the second material treatment in succession.

In some aspects, the techniques described herein relate to a tool accessory, wherein the entire unitary body has undergone the first material treatment, and wherein only the second side and a part of the intermediate portion have undergone the second material treatment.

In some aspects, the techniques described herein relate to a tool accessory, further comprising a drive portion formed at the first end, the drive portion configured to be engaged by an output shaft of a tool, and a tip formed at the second end, the tip configured to engage a workpiece, wherein a desired hardness for the drive portion is different than a desired hardness for the tip.

In some aspects, the techniques described herein relate to a tool accessory, wherein a transverse cross-section of the unitary body at the drive portion is different than the cross-section at the tip such that the cross-section of the intermediate portion varies between the drive portion and the tip, and wherein the hardness gradient varies by different amounts at a center of the cross-section and at a periphery of the cross-section.

In some aspects, the techniques described herein relate to a tool accessory, wherein at least a portion of a profile of the hardness gradient is generally parabolic.

In some aspects, the techniques described herein relate to a tool accessory, wherein the first material treatment includes heat treatment and the second material treatment includes induction tempering.

In some aspects, the techniques described herein relate to a tool accessory, wherein the first hardness is approximately 44-52 HRC, wherein the second hardness is approximately 57-62 HRC, and wherein the hardness of the hardness gradient changes between approximately 46 HRC and approximately 62 HRC.

In some aspects, the techniques described herein relate to a method of manufacturing a tool accessory configured to be turned by a tool includes forming, from a common raw material, a unitary body as a single piece; and heat treating the entire unitary body with a first heat treatment, the first heat treatment providing a first hardness for approximately the entire tool accessory. The method further includes heat treating a portion of the unitary body with a second heat treatment different than the first heat treatment, the second heat treatment providing a second hardness for less than approximately the entire tool accessory, wherein the second hardness is different than the first hardness.

In some aspects, the techniques described herein relate to a method of manufacturing, wherein the unitary body includes a first end, a second end opposite the first end, and an intermediate portion extending axially between the first end and the second end, the method further comprising providing the second heat treatment once the first heat treatment has been applied to the entire unitary body, defining a desired hardness region in an axial direction from the second end toward the first end, and applying the second heat treatment to the second end until the second hardness in the desired hardness region is approximately equal to a desired hardness.

Other aspects of the invention will become apparent by consideration of the detailed description and accompanying drawings.

### BRIEF DESCRIPTION OF THE DRAWINGS

FIG. 1 is a perspective view of a tool accessory known in the art.

FIG. 2 is a perspective view of a tool accessory, according to one embodiment of the present disclosure.

FIG. 3 is a cross-sectional view of the tool accessory of FIG. 2, including profiles corresponding with a hardness and a toughness of the tool accessory along a length of the tool accessory.

FIG. 4A is a perspective view of the tool accessory of FIG. 1 at a first step in a manufacturing process, according to one embodiment of the present disclosure.

FIG. 4B is a perspective view of the tool accessory of FIG. 1 at another step in the manufacturing process.

FIG. 4C is a perspective view of the tool accessory of FIG. 1 at yet another step in the manufacturing process.

FIG. 4D is a perspective view of the tool accessory of FIG. 1 at still another step in the manufacturing process.

FIG. 5 is a process view of a method of manufacturing the tool accessory of FIG. 1, according to one embodiment of the present disclosure.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

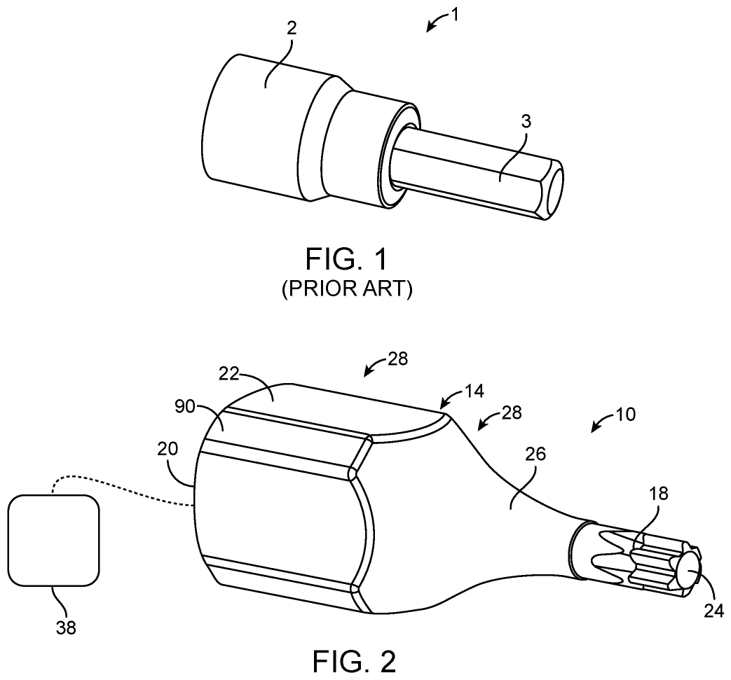

Referring to FIG. 1, a known bit socket assembly 1 is illustrated as having a base socket 2 and a separate bit tip 3 pressed into the base socket 2. The bit socket assembly 1 may thus be referred to as a two-piece bit socket assembly. Typically, the base socket 2 and the bit tip 3 are formed of different materials and treated separately based on their application. For example, the base socket 2 may be formed and treated for applications requiring a high toughness, while the bit tip 3 may be formed and treated for applications requiring a high hardness. The base socket 2 and the bit tip 3 are often formed and treated separately before they are pressed together.

Referring now to FIG. 2, a tool accessory 10 according to one embodiment of the present disclosure includes a body 14 having a unitary (e.g., single, monolithic, etc.) construction. The body 14 includes a tip 18, a drive portion 22, and a shank 26 defining an intermediate portion 28 of the body 14 to interconnect the tip 18 and the drive portion 22. In the illustrated embodiment, the drive portion 22 defines a first end 20 of the tool accessory 10, and the tip 18 defines a second end 24 of the tool accessory 10. In other embodiments, the tip may define the first end 20, and the drive portion 22 may define the second end 24. In the illustrated embodiment, the tool accessory 10 is a socket-type bit but could be another type of tool accessory (e.g., tool bit, drill bit, insert bit, and/or the like). The tool accessory 10 may be selectively and/or interchangeably useable with a driver tool, such as a power tool (e.g., impact driver, drill, etc.), a hand tool (e.g., socket wrench, socket wrench screwdriver, etc.), or the like.

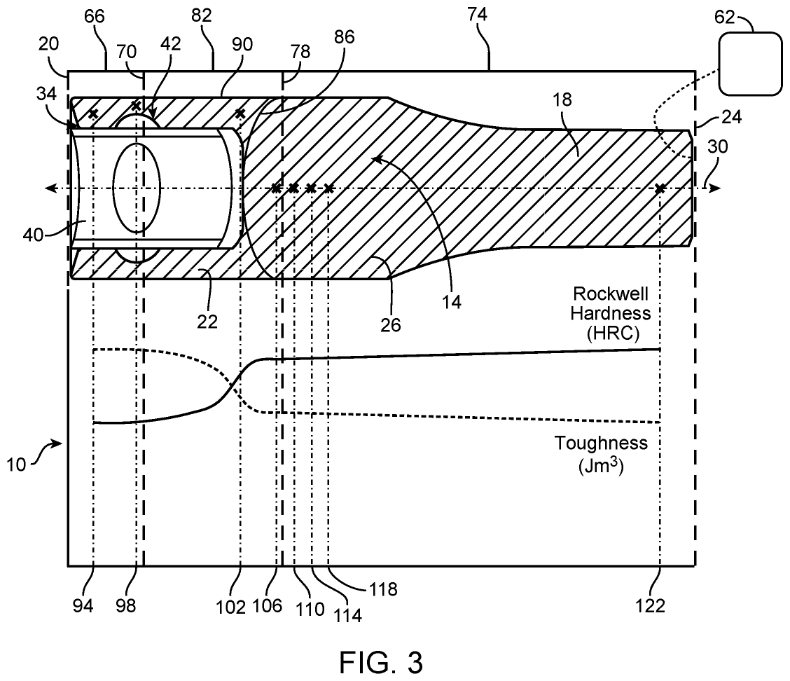

As illustrated in FIGS. 2 and 3, the tip 18, drive portion 22, and shank 26 are disposed along an axis 30 of the tool accessory 10; the axis extending centrally through the first end 20 and the second end 24. The drive portion 22 of the tool accessory 10 includes a socket 34 disposed along the axis 30 adjacent the first end 20. The socket 34 may have a cross-section 38 that is substantially polygonal and sized to receive a standard drive or shaft (e.g., ¼, ⅜, or ½ inch). In the illustrated embodiment, the cross-section 38 is substantially square. In other embodiments, the socket may have other cross-sectional profiles (e.g., hexagonal, splined, or the like) and sizes.

In general, the drive portion 22 is sized and shaped to be engaged by a shaft or output member 40 of said driver tools. The tool accessory 10 may further include a recess 42 within the socket 34, and the output member 40 of the driver tool may include a detent ball that is biased toward the recess 42 in a direction substantially perpendicular to the axis 30. In other embodiments, the recess and detent ball may be disposed on alternate portions of the tool accessory 10 and the output member.

With continued reference to FIGS. 2 and 3, the tip 18 is configured to engage a workpiece (e.g., fastener, bit, extension, etc.). The tip 18, in one example construction, may include a screwdriver-type tip (e.g., hex, slotted, square, cross, star, etc.). As illustrated specifically in FIG. 3, the tip 18 may alternately or additionally include an accessory drive portion having a substantially square cross-section 62. The accessory drive portion (e.g., tip 18) may be configured and sized (e.g., ¼, ⅜, or ½ inch) to be received by a drive socket of an additional accessory. The drive portion may include a detent ball arrangement similar to the recess and ball detent previously discussed. In other example constructions, based on a desired application, the tip 18 may include a receiver, driver, or adapter.

Referring still to FIGS. 2 and 3, the entire tool accessory 10 may be formed of high speed steel (HSS), other wear resistant metal alloys, an impact resistant steel alloy (e.g., SAE 6150 low-alloy steel), or a material composed of wear and impact resistant alloys. In the illustrated embodiment, the entire tool accessory 10 is composed of S2 tool steel (e.g., UNS T41902), which is designated as a shock resisting steels designed to have high impact resistance (e.g., toughness), as well as strength and hardness. Stated another way, the tip 18, the drive portion 22, and the shank 26 are unitarily formed as one piece from a single material.

In order to provide a combination of impact resistance and wear resistance, portions of the tool accessory 10 may be locally treated (e.g., hardened, tempered, etc.). More specifically, as described in greater detail below, the entire body 14 may be initially subjected to a first heat treatment, or a first material treatment, to achieve a first hardness for approximately the entire body 14 to temporarily unify the hardness and the toughness of the tool accessory 10. Next, a portion of the body 14 may be subsequently subjected to an induction tempered treatment, or a second material treatment, to achieve a second, lower hardness for a specific portion of the body 14. For example, the entire body 14 may be treated so the entire tool accessory 10 has a high hardness required by the tip 18 for increased wear resistance. Next, a portion of the tool accessory 10 may be induction tempered so the drive portion 22 has a lower hardness and high toughness required for increased impact resistance. As such, an amount of the shank 26 that is subjected to the second material treatment may decrease from the drive portion 22 to the tip 18. Alternatively, an amount of the shank 26 that is subjected to the second material treatment may decrease from the tip 18 to the drive portion 22

With specific reference to FIG. 3, the tool accessory 10 has a first hardness in a first zone 66 extending between the first end 20 and a first side 70 of the intermediate portion 28. The tool accessory 10 has a second hardness in a second zone 74 extending between the second end 24 and a second side 78 of the intermediate portion 28. The intermediate portion 28 may also serve as a hardness transition zone 82 that provides a hardness gradient (e.g., increase or decrease, slope, etc.) between the first hardness zone 66 and the second hardness zone 74. In some embodiments, the hardness gradient may have a profile 86 that is generally parabolic. In some embodiments, the profile 86 may be another shape. It should be understood that, although the profile is shown through a first transverse cross-section of the body 14, as represented vertically in FIG. 3, the profile is substantially similar through a second transverse cross-section of the body 14 that is generally normal to the first transverse cross-section.

More specifically, a hardness of the body 14 at a central portion of the profile 86 (e.g., proximate the axis 30) may be lower than at an end of the profile 86 (e.g., proximate a periphery of the body 14/transverse cross-section). In other words, with brief reference to FIG. 2, corners 90 of the intermediate portion 28 of the tool accessory 10 may have a higher toughness that decreases along a curved part of the profile 86 towards the axis 30.

Referring still to FIG. 3, a hardness of the tool accessory 10 may be measured or defined at various points between the first end 20 and the second end 24. A first point 94 may be positioned in the first zone 66, and a second point 98 may be positioned in the first zone 66 between the first point 94 and the second end 24. A third point 102 may be positioned in the transition zone 82, and a fourth point 106 may be positioned in the transition zone 82 between the third point 102 and the second end 24. A fifth point 110, a sixth point 114, a seventh point 118, and an eighth point 122 may be positioned successively in the second zone 74.

The hardness of the tool accessory 10 at the first point 94 and the second point 98 may be hardened for high impact resistance to between approximately 44 Rockwell-C hardness (“HRC”) and approximately 52 HRC. Specifically, the hardness of the tool accessory 10 at the first point 94 and the second point 98 may be hardened for high impact resistance to approximately 48 HRC. The hardness of the tool accessory 10 at the third point 102 and the fourth point 106 may be between approximately 46 HRC and approximately 62 HRC, such that the transition zone 82 provides the hardness gradient between the first zone 66 and the second zone 74. The transition zone 82 (e.g., the third point 102 and the fourth point 106) may also act as a heat sink between the first zone 66 and the second zone 74. The hardness of the tool accessory 10 at the fifth point 110, the sixth point 114, the seventh point 118, and the eighth point 122 may be hardened for high wear resistance to between approximately 57 HRC and approximately 62 HRC. Specifically, the hardness of the tool accessory 10 at the fifth point 110, the sixth point 114, the seventh point 118, and the eighth point 122 may be hardened for high wear resistance to approximately 60. In the illustrated embodiment, in contrast to the first end 20 in the first zone 66, the intermediate portion 28 in the transition zone 82 is not locally heat treated (e.g., induction tempered). In some embodiments, a total hardness difference between the first end 20 and the second end 24 is between approximately 4 HRC and approximately 20 HRC.

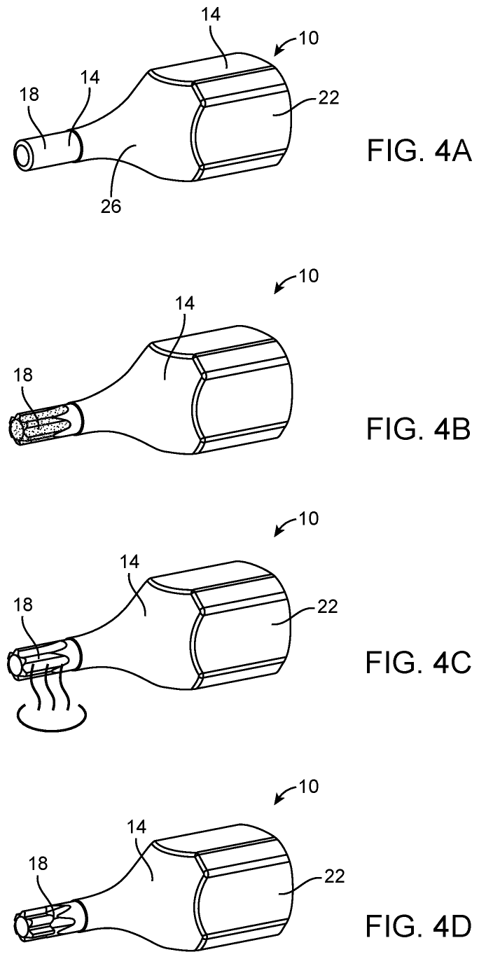

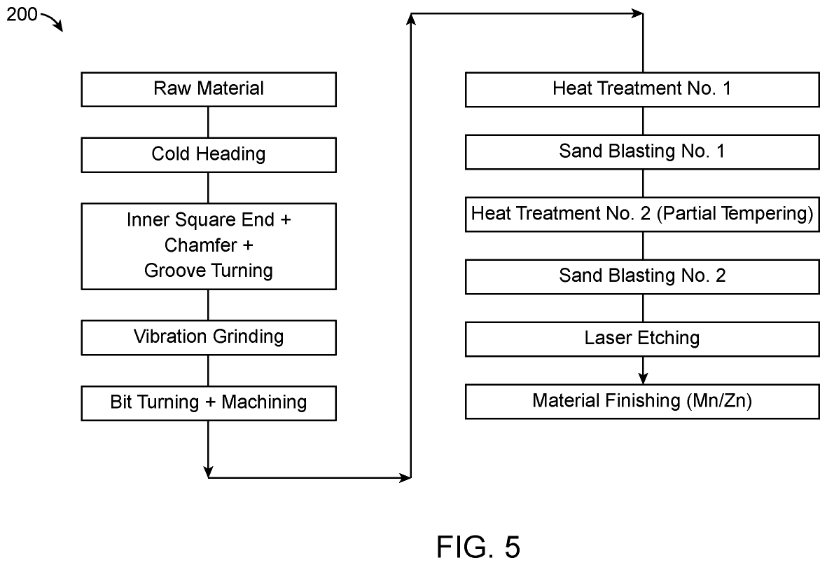

Referring now to FIGS. 4A-5, a method of manufacturing 200 the tool accessory 10, according to one embodiment, includes forming the body 14 from a common raw material as a single piece (FIG. 4A). Next, the body 14 may be cold headed, after which the socket 34 may be formed, including chamfering of edges and turning of grooves. In some embodiments, the socket 34 may be formed with a depth of approximately 8 millimeters (“mm”) to approximately 13 mm, and the drive portion 22 may have a width of approximately ¼ inches. In other embodiments, the socket 34 may be formed with a depth of approximately 10 mm to approximately 15 mm, and the drive portion 22 may have a width of approximately ⅜ inches. In some example construction, a depth of the first zone 66 is approximately the same as the depth of the socket 34. In other example construction, a depth of the first zone 66 and the transition zone 82 is similar to or greater than the depth of the socket 34.

Next, the body 14 may undergoes vibration grinding. Following vibration grinding, in one embodiment, the tip 18 and/or other parts of the body 14 may be turned, machined, and/or the like (FIG. 4B). Next, the entire body 14 may undergo the first material treatment to achieve the first hardness for approximately the entire body 14. The body 14 may then be sand blasted or otherwise cleaned a first time, following which a first portion of the body 14, such as the drive portion 22 or the tip 18, may undergo the second material treatment to achieve the second, lower hardness (i.e., higher toughness). In the illustrated embodiment, the drive portion 22 undergoes the second material treatment to increase its impact resistance. In other contemplated constructions, following the first material treatment, the tip 18 may be locally induction hardened (FIG. 4C) for increased wear resistance. Next, the body 14 may be sand blasted or otherwise cleaned a second time, after which the body 14 may be laser etched and finished (FIG. 4D). In one example construction, the body 14 undergoes a manganese-zinc finishing (e.g., electroplating, electro-coating, or the like).

Thus, the disclosure provides, among other things, a single-piece tool accessory of improved impact resistance and wear resistance. Various features and advantages of the disclosure are set forth in the following claims.

What is claimed is:

1. A tool accessory comprising:
a drive portion configured to be engaged by an output shaft of a tool, the drive portion having a first hardness;
a tip configured to engage a workpiece, the tip having a second hardness different than the first hardness; and
a shank interconnecting the drive portion and the tip, the shank having a third hardness different than the first hardness and different than the second hardness,
wherein the third hardness is between the first hardness and the second hardness, and
wherein the drive portion, the shank, and the tip are formed as a unitary body from a common material.

2. The tool accessory of claim 1,
wherein the drive portion has a first toughness,
wherein the tip has a second toughness different than the first toughness,
wherein the shank has a third toughness different than the first toughness and different than the second toughness, and
wherein the third toughness is between the first toughness and the second toughness.

3. The tool accessory of claim 2, wherein the drive portion, the tip, and the shank are initially subjected to a first heat treatment to temporarily unify the hardness and the toughness of the tool accessory, and wherein one of the drive portion and the tip are subsequently subjected to a second heat treatment different than the first heat treatment.

4. The tool accessory of claim 3, wherein the drive portion and not the tip is subjected to the second heat treatment, and wherein an amount of the shank that is subjected to the second heat treatment decreases from the drive portion to the tip.

5. The tool accessory of claim 3, wherein the tip and not the drive portion is subjected to the second heat treatment, and wherein an amount of the shank that is subjected to the second heat treatment decreases from the tip to the drive portion.

6. The tool accessory of claim 1, wherein the drive portion includes a socket for receiving the output shaft of the tool, and wherein the socket has a substantially polygonal cross-section.

7. The tool accessory of claim 6, wherein one of the output shaft and the drive portion includes a detent ball, and the other of the output shaft and the drive portion includes a recess for receiving the detent ball, and wherein the socket has a substantially square cross-section.

8. The tool accessory of claim 3, wherein the second heat treatment includes induction tempering.

9. The tool accessory of claim 3,
wherein the first hardness is approximately 44-52 HRC,
wherein the second hardness is approximately 57-62 HRC, and
wherein the third hardness is approximately 46-62 HRC.

10. The tool accessory of claim 3,
wherein the first hardness is approximately 48 HRC, and
wherein the second hardness is approximately 60 HRC.

11. A tool accessory comprising:
a unitary body including a first end, a second end opposite the first end, and an intermediate portion extending axially between the first end and the second end, the first end, the second end, and the intermediate portion being formed from a common material;
a first zone extending between the first end and a first side of the intermediate portion, the first zone having a first hardness;
a second zone extending between the second end and a second side the intermediate portion, the second zone having a second hardness different than the first hardness; and
a transition zone between the first zone and the second zone, at least a portion the transition zone having a hardness gradient between the first hardness and the second hardness,
wherein the first side has undergone a first material treatment configured to provide the first hardness, and
wherein the second side has undergone a second material treatment that is different than the first material treatment and configured to provide the second hardness.

12. The tool accessory of claim 11, wherein the second side has undergone the first material treatment and the second material treatment in succession.

13. The tool accessory of claim 11, wherein the entire unitary body has undergone the first material treatment, and wherein only the second side and a part of the intermediate portion have undergone the second material treatment.

14. The tool accessory of claim 11, further comprising:
a drive portion formed at the first end, the drive portion configured to be engaged by an output shaft of a tool; and
a tip formed at the second end, the tip configured to engage a workpiece,
wherein a desired hardness for the drive portion is different than a desired hardness for the tip.

15. The tool accessory of claim 14, wherein a transverse cross-section of the unitary body at the drive portion is different than the cross-section at the tip such that the cross-section of the intermediate portion varies between the drive portion and the tip, and wherein the hardness gradient varies by different amounts at a center of the cross-section and at a periphery of the cross-section.

16. The tool accessory of claim 15, wherein at least a portion of a profile of the hardness gradient is generally parabolic.

17. The tool accessory of claim 11, wherein the first material treatment includes heat treatment and the second material treatment includes induction tempering.

18. The tool accessory of claim 11,
wherein the first hardness is approximately 44-52 HRC,
wherein the second hardness is approximately 57-62 HRC, and
wherein the hardness of the hardness gradient changes between approximately 46 HRC and approximately 62 HRC.

19. A method of manufacturing a tool accessory configured to be turned by a tool, the method comprising:
forming, from a common raw material, a unitary body as a single piece;
heat treating the entire unitary body with a first heat treatment, the first heat treatment providing a first hardness for approximately the entire tool accessory; and
heat treating a portion of the unitary body with a second heat treatment different than the first heat treatment, the second heat treatment providing a second hardness for less than approximately the entire tool accessory, wherein the second hardness is different than the first hardness.

20. The method of claim 19, wherein the unitary body includes a first end, a second end opposite the first end, and an intermediate portion extending axially between the first end and the second end, the method further comprising:
providing the second heat treatment once the first heat treatment has been applied to the entire unitary body;
defining a desired hardness region in an axial direction from the second end toward the first end; and
applying the second heat treatment to the second end until the second hardness in the desired hardness region is approximately equal to a desired hardness.
